(19) United States
(12) Patent Application Publication
(10) Pub. No.: US 2015/0304174 A1
(43) Pub. Date: Oct. 22, 2015

(54) IDENTIFIERS FOR SPOKE-PES IN HUB-SPOKE NETWORKS

(71) Applicant: Hangzhou H3C Technologies Co., Ltd., Hangzhou City, Zhejiang (CN)

(72) Inventor: Changfeng Zhao, Beijing (CN)

(21) Appl. No.: 14/440,973

(22) PCT Filed: Nov. 8, 2013
(86) PCT No.: PCT/CN2013/086740

§ 371 Date: May 6, 2015

(30) Foreign Application Priority Data
Nov. 8, 2012 (CN) 201210443911.2

(51) Int. Cl. H04L 12/24; H04L 29/08

(52) U.S. Cl. CPC H04L 41/5054; H04L 67/10

(57) ABSTRACT

A method for allocating identifiers to Spoke-PEs in a Hub-Spoke network. A same private network identifier is allocated to the Spoke-PEs to identity the Hub-Spoke network. A unique service identifier is allocated to the Spoke-PEs in the Hub-Spoke network, respectively, to uniquely identify the Spoke-PEs in the Hub-Spoke network.

### BACKGROUND

A Virtual Private LAN Service (VPLS) is a point-to-multiple-point Layer 2 Virtual Private Network (L2VPN) service provided in a public network. The VPLS connects regionally separated user network sites through a Multiprotocol Label Switching (MPLS) or an Internet Protocol (IP) backbone network. Entities in the backbone network act as a virtual switch that connects the user network sites together. A service provider provides the VPLS for different user networks by providing different virtual switches on the backbone network. The backbone network is transparent to the user network sites, and each of the user network sites operates in a manner similar to a local area network.

### BRIEF DESCRIPTION OF THE DRAWINGS

Features of the present disclosure are illustrated by way of non-limiting examples, and like numerals indicate like elements, in which:

FIG. 1 is a schematic diagram of an example Hub-Spoke network and the components of messages when transmitted in the Hub-Spoke network;

FIG. 2 is a schematic flow chart of an example method for allocating identifiers to Spoke-PEs in a Hub-Spoke network;

FIG. 3 is a schematic diagram of an example structure for a service identification field for pseudowire element information;

FIG. 4 is a schematic flow chart of an example method for encapsulating tags in a message for transmission in a Hub-Spoke network;

FIG. 5 is a schematic flow chart of an example method for transmitting a message in a Hub-Spoke network;

FIG. 6 is a schematic flow chart of an example method for transmitting a message in a Hub-Spoke network;

FIG. 7(a) is an example user instance medium access control (MAC) address table and FIG. 7(b) is an example MAC address forwarding table;

FIG. 8 is a schematic flow chart of an example method for populating a table in a Hub-Spoke network;

FIG. 9 is a schematic flow chart of an example method for MAC addressing in a Hub-Spoke network;

FIG. 10 is a schematic flow chart of an example method for MAC addressing in a Hub-Spoke network;

FIG. 11 is a schematic diagram of an example Hub-PE device in a Hub-Spoke network;

FIG. 12 is a schematic diagram of an example Hub-PE device in a Hub-Spoke network;

FIG. 13 is a schematic diagram of an example Spoke-PE device in a Hub-Spoke network;

FIG. 14 is a schematic diagram of an example Hub-CE device in a Hub-Spoke network; and

FIG. 15 is a schematic diagram of an example Hub-CE device in a Hub-Spoke network.

### DETAILED DESCRIPTION OF THE INVENTION

The present disclosure describes an example of a method for allocating identifiers to Spoke-PEs in a Hub-Spoke network. In the example, a first, that is same, private network identifier is allocated to the Spoke-PEs to identity the Hub-Spoke network, and a unique service identifier is determined to uniquely identify a Spoke-PE from the plurality of Spoke-PEs in the Hub-Spoke network. The unique service identifier is allocated to and obtained at the Spoke-PE. This method for allocating identifiers may reduce the number of the private network identifiers contained in private network tags of messages transmitted in the Hub-Spoke network.

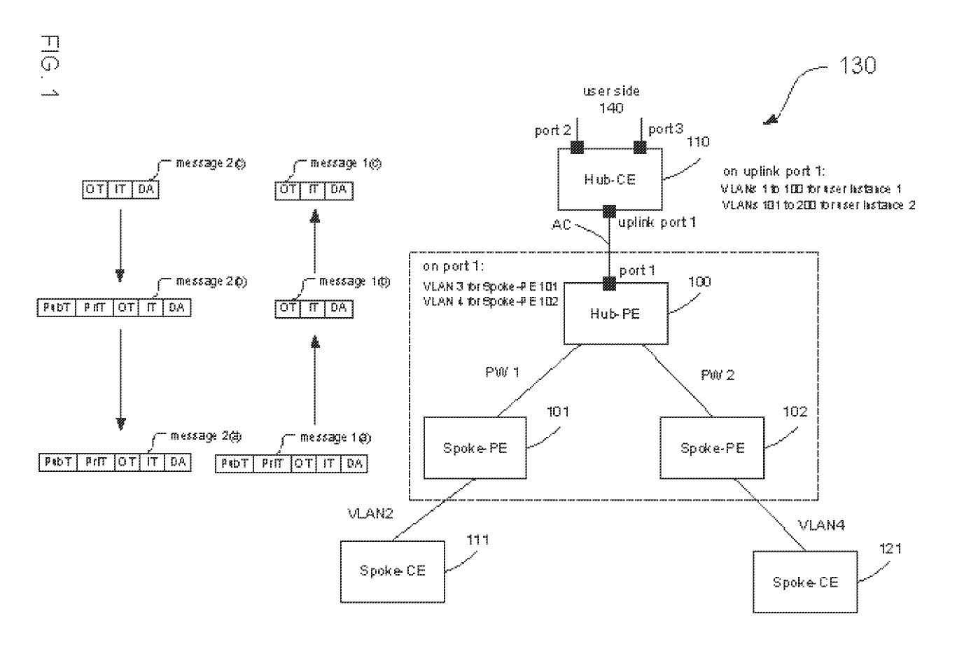

In the example shown in FIG. 1, a Hub-Spoke network 130 includes a provider network, shown in a dashed box, and a customer network. The provider network includes a Hub service provider network edge device (Hub-PE) 100, a plurality of Spoke service provider network edge devices (Spoke-PE) 101, 102. The customer network includes a customer network edge device (Hub-CE) 110 and a plurality of Spoke customer network edge devices (Spoke-CE) 111, 121.

In the Hub-Spoke network 130 shown in FIG. 1, spoke sites (i.e., the Spoke-PEs or Spoke-CEs) normally do not communicate directly with each other. Instead they communicate via the hub sites (i.e., the Hub-PE 100 and the Hub-CE 110). As a result, the hub sites manage traffic in a centralized manner.

The Hub-PE 100 in the Hub-Spoke network 130 establishes a pseudowire (PW) connection with each of the Spoke-PEs 101, 102. In particular, a PW connection 1 (PW 1) is established to connect the Hub-PE 100 and the Spoke-PE 101, and a PW connection 2 (PW 2) is established to connect the Hub-PE 100 and the Spoke-PE 102. The Hub-PE 100 allocates an attachment circuit (AC) (not shown in FIG. 1) to each of the Spoke-PEs 101, 102. The AC includes a port and a virtual local area network (VLAN), wherein the port is connected to the Hub-CE 110, and the VLAN is a VLAN on the port. Specifically, the AC allocated to the Spoke-PE 101 includes the port 1 and a VLAN 3 on the port 1, and the AC allocated to the Spoke-PE 102 includes the port 1 and a VLAN 4 on the port 1. Each of the VLANs in the Hub-Spoke network 130 has a virtual local area network identifier (VLAN ID). The VLAN ID of the VLAN 3 on port 1 is 3, and the VLAN ID of the VLAN 4 on port 1 is 4. The PW 1, PW 2 of the Spoke-PEs 101, 102 are associated with the AC allocated to respective Spoke-PEs. The Spoke-CE 111 accesses the Spoke-PE 101 via a VLAN 2 therebetween, and the Spoke-CE 121 accesses the Spoke-PE 102 via a VLAN 4 therebetween.

Examples of the present disclosure are described based on one HUB-Spoke network instance or one user instance unless stated otherwise. It will be appreciated that the present disclosure can be applied to multiple Hub-Spoke network instances simultaneously.

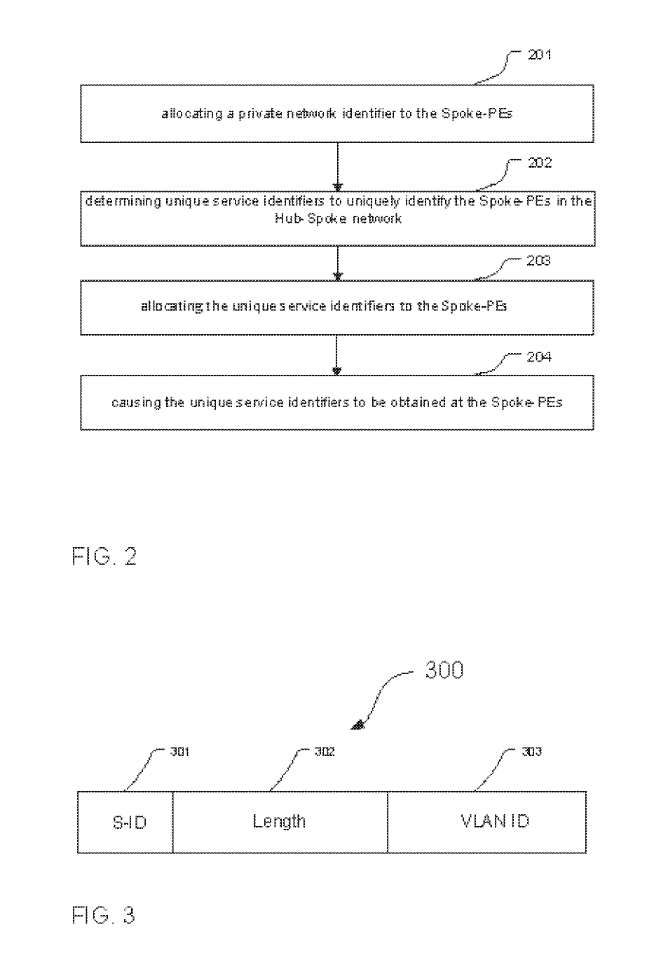

Referring to FIG. 2, the Hub-PE 100 allocates 201 a private network identifier 26 to the Spoke-PEs 101, 102 to identify the HUB-Spoke network 130 in which the Spoke-PEs 101, 102 reside. The private network identifier is the same to the Spoke-PEs 101, 102. The Hub-PE determines 202 unique service identifiers to uniquely identify the Spoke-PE 101, 102, respectively. The Hub-PE 100 also allocates 203 the unique service identifiers to the Spoke-PEs 101, 102, respectively, to uniquely identify the Spoke-PEs 101, 102.

Two example approaches by which the Hub-PE causes the Spoke-PEs 101, 102 to obtain 204 their respective service identifiers allocated by the Hub-PE 100 will now be described.

The first approach is for the Spoke-PEs 101, 102 to proactively request the service identifier allocated thereto by the Hub-PE 100.

The second approach is that the Hub-PE 100 sends the service identifier allocated to respective Spoke-PEs 101, 102 with PW element information sent to the Spoke-PEs 101, 102. Upon receipt of the PW element information, the Spoke-PEs 101, 102 obtain the service identifier from the PW element information.

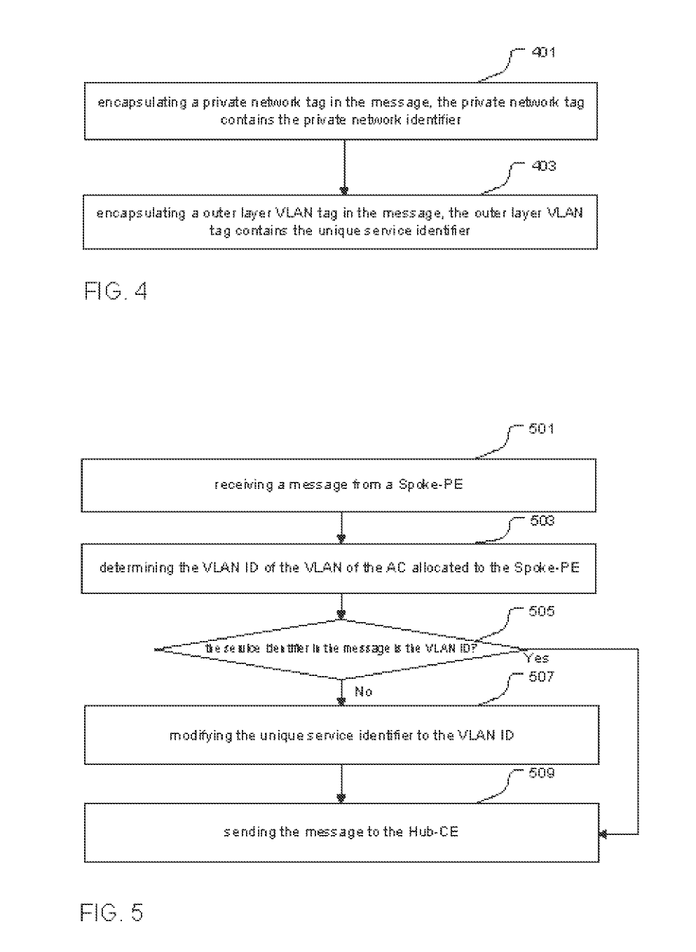

As a result, when the Spoke-PEs 101, 102 send a message to the Hub-PE 100, the Spoke-PEs 101, 102 encapsulate in the message an outer layer VLAN tag containing the unique service identifier and a private network tag containing the private network identifier, as described in detail with reference to FIG. 4. The Hub-PE 100, when receiving the message from the Spoke-PEs 101, 102, identifies which Spoke-PE sent the message according to the unique service identifier contained in the message.

In one implementation, a remote Label Distribution Protocol (LDP) operates between the Hub-PE 100 and the Spoke-PEs 101, 102 to negotiate the L2VPN information. During the negotiation process, a service identification (Service-ID) field is added to the PW element information sent by the Hub-PE 100 to the Spoke-PEs 101, 102.

Referring to FIG. 3, an example structure 300 of a service identification field for PW element information is shown. The example has a Type-Length-Value (TLV) structure. The type or S-ID field 301 indicates that the TLV contains Service-ID information; the Length field 302 indicates the length of the TLV; the value or VLAN ID field 303 contains the unique service identifier allocated to the Spoke-PE 101, 102 by the Hub-PE 100.

Depending on the result of the negotiation process described above, the service identifier can be the VLAN ID of the VLAN of the AC allocated to the respective Spoke-PEs 101, 102. In other examples the service identifier may be another unique service identifier that can uniquely identify the Spoke-PEs 101, 102 using an allocation method separated from the PW element information. In the example described with reference to FIG. 2, the service identifier of the Spoke-PEs 101, 102 is the VLAN ID of the VLAN of the AC allocated to the respective Spoke-PEs. That is, the Hub-PE 100 allocates 3 to the Spoke-PE 101 as the service identifier, and 4 to the Spoke-PE 102 as the service identifier. As a variation of this example, the Hub-PE 100 allocates 10 to the Spoke-PE 101 as the service identifier, and 11 to the Spoke-PE 102 as the service identifier. In this case, the service identifier of the Spoke-PEs 101, 102 is not the VLAN ID of the VLAN of the AC allocated to the respective Spoke-PEs.

When the AC allocated to a Spoke-PE by the Hub-PE has multiple VLANs, one of the VLAN IDs of the VLANs is allocated to the Spoke-PE as the service identifier. In another example, all of the VLAN IDs are allocated to the Spoke-PE and the Spoke-PE selects one of them as the service identifier.

Continuing the above example, the same private network identifier, specifically 26, is allocated to the Spoke-PEs 101, 102 in the Hub-Spoke network 130 to identify the HUB-Spoke network 130. The unique service identifiers allocated to the Spoke-PEs 101, 102 (3 for the Spoke-PE 101, 4 for the Spoke-PE 102) uniquely identify the Spoke-PEs 101, 102.

Transmission from Spoke PE to Hub CE

Referring to FIGS. 1 and 4, an example method for encapsulating tags in a message for transmission in a Hub-Spoke network is described.

The Spoke-PE 101 encapsulates tags in a message 1(a) containing data (indicated as “DA” in FIG. 1) to be sent. Particularly, a public network tag (indicated as “PubT”) is encapsulated in the message 1(a). The Spoke-PE further encapsulates 401 a private network tag (indicated as “PriT”) in the message 1(a). The private network tag PriT contains the private network identifier allocated to the Spoke-PE 101. An outer layer VLAN tag (indicated as “OT”) is also encapsulated 403 in the message 1(a), wherein the outer layer VLAN tag OT contains the unique service identifier. An inner layer VLAN tag (indicated “IT”) is further encapsulated in the message 1(a).

Referring to FIGS. 1 and 5, an example method for transmitting a message in a Hub-Spoke network is described.

In the example shown in FIG. 5, the message 1(a) is received 501 from the Spoke-PE 101 at the Hub-PE 100, which comprises the public network tag PubT, the private network tag PriT, the outer layer VLAN tag OT, the inner layer VLAN tag IT and the data DA. The service identifier, i.e., 3, allocated by the Hub-PE 100 to the Spoke-PE 101 is contained in the outer layer VLAN tag OT of the message 1(a), and the private network identifier, i.e., 26, allocated by the Hub-PE 100 is contained in the private network tag PriT of the message 1(a).

Upon receipt of the message 1(a) at the Hub-PE 100, the Hub-PE 100 decapsulates, also referred to as pops out, the public network tag PubT and the private network tag PriT from the message 1(a) to a message 1(b). The Hub-PE 100 determines that the message 1(a) is sent from the Spoke-PE 101 because the service identifier contained in an outer layer VLAN tag OT of the message 1(a) is 3, which is the same as the service identifier of the Spoke-PE 101. The Hub-PE 100 in turn determines 503 the VLAN ID of the VLAN of the AC allocated to the Spoke-PE 101 is 3 because the VLAN of the AC allocated to the Spoke-PE 101 is the VLAN 3.

The Hub-PE 100 determines 505 whether the service identifier contained in the outer layer VLAN tag OT of the message 1(a) is the VLAN ID of the VLAN of the AC allocated to the Spoke-PE 101. In this example, the service identifiers contained in the outer layer VLAN tag OT of the message 1(a) and the VLAN ID of the VLAN 3 are both 3. The Hub-PE 100 then sends 509 the message 1(b) to the Hub-CE 110 via the port 1 to be received as message 1(c).

As an variation of this example, if the service identifier contained in the outer layer VLAN tag OT of the message 1(a) is not the VLAN ID of VLAN of the AC allocated to the Spoke-PE 101, the Hub-PE 100 modifies 507 content in the outer layer VLAN tag OT of the message 1(b) from the service identifier to the VLAN ID of the VLAN of the AC allocated to the Spoke-PE 101 and then sends 509 the message 1(b) to the Hub-CE 110 via the port 1. As a result, the service identifier contained in the outer layer VLAN tag OT of the message 1(b) sent by the Hub-PE 100 to the Hub-CE 110 is identical with the VLAN ID of the VLAN of the AC allocated to the Spoke-PE 101.

Upon receipt of the message 1(b) at the Hub-CE 110, the Hub-CE 110 obtains the service identifier (i.e., 3) contained in the outer layer VLAN tag OT sent from the Hub-PE 100.

In one Hub-Spoke network instance, the Hub-PE only has one port that communicates with the Hub-CE, and messages are sent directly through the port. Where there are multiple Hub-Spoke network instances, these instances are differentiated based on the private network tags PriT allocated to the Spoke-PEs in each of the Hub-Spoke network instances. As a result, the port connected to the Hub-CE of each of the Hub-Spoke network instances can be determined accordingly.

It can be seen from the above example that, at the Hub-CE 110, since the outer layer VLAN tag OT of the message 1(b) contains the service identifier that is the same as the VLAN ID of VLAN 3, it is not necessary to determine via which VLAN on the port 1 the message 1(b) is sent to the Hub-CE 110. Further, the AC that includes the VLAN 3 can be determined based on the VLAN ID. As a result, the Spoke-PE 101 to which the AC is allocated and the PW connection to the Spoke-PE 101, which is associated with the AC can also be determined. In this way messages can be sent from the Hub-CE 110 to the Spoke-PE 101 through the AC and the PW connection.

Transmission from Hub-CE to Spoke-PE

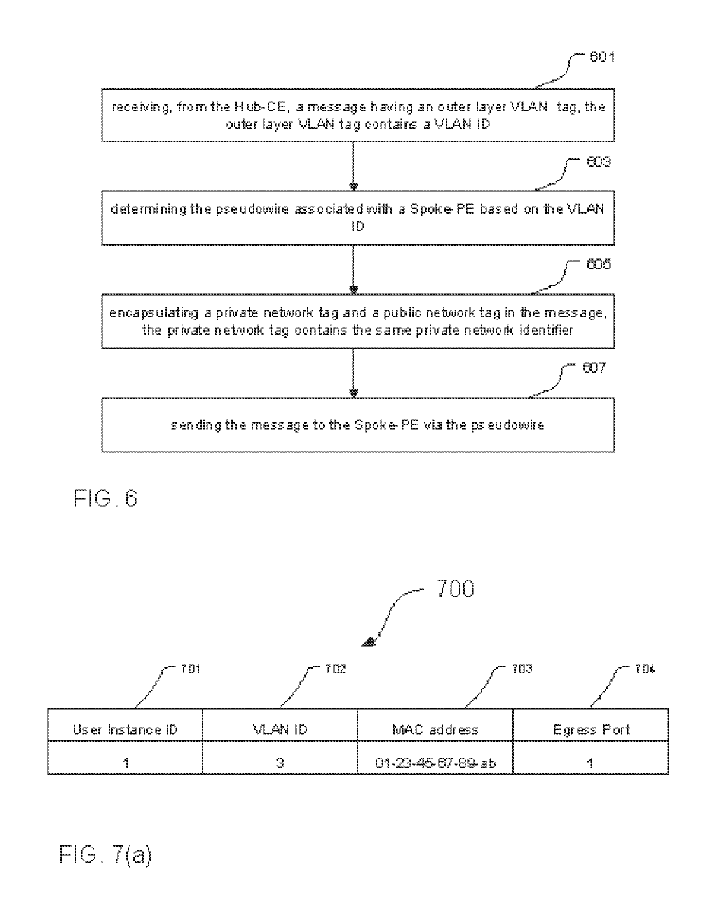

Referring to FIGS. 1 and 6, an example method for transmitting a message in a Hub-Spoke network is described.

As the Hub-CE 110 has obtained the service identifier (i.e., 3) allocated to the Spoke-PE 101 from an outer layer VLAN tag OT of a message sent from the Spoke-PE 101 through, for example but not limited to, the process described with reference to FIG. 5, when the Hub-CE 110 sends a message 2(c), an outer layer VLAN tag OT containing the service identifier is encapsulated in the message 2(c).

In the example shown in FIG. 6, the Hub-PE 100 receives 601 the message 2(c) sent from the Hub-CE 110. Since the outer layer VLAN tag OT of the message 2(c) contains the VLAN ID of VLAN 3, the Hub-PE 100 determines the AC that includes the VLAN 3 on the port 1. Based on this, the Hub-PE 100 determines the Spoke-PE to which the AC is allocated, which is the Spoke-PE 101 in this example.

Then the PW 1 connecting the Hub-PE 100 and the Spoke-PE 101 are in turn determined 603 by the Hub-PE 100.

The Hub-PE 100 encapsulates 605 in the message 2(c) a private network tag PriT, which contains the private network identifier (i.e., 26) allocated to the Spoke-PE 101, and a public network tag PubT, to form a message 2(b).

The message 2(b) is then sent 607 to the Spoke-PE 101 through the PW 1 to be received as message 2(a). As a variation of this example, prior to sending the message 2(b) to the Spoke-PE 101, the Hub-PE 100 modifies content in the outer layer VLAN tag OT of the message 2(b) from 3 to 0 in order to facilitate processing of the message 2(c) at the Spoke-PE 101 upon receipt by the Spoke-PE 101.

In the above example, the Spoke-PE 101 sending the message is not determined based on the private network tag PriT and the source medium access control address is not determined at the Hub-PE 100, nor are entries of the MAC address table on the Hub-PE 100 searched. This way there being insufficient entries for the MAC address table on the Hub-PE 100 may be alleviated. To perform a MAC addressing function in the Hub-Spoke network, a Hub-CE, also shown as the Hub-CE 110 in FIG. 1, is described accordingly.

It should be noted that more than one user instances are used to describe the MAC addressing function at the Hub-CE 110.

The Hub-CE 110 creates a user instance for each Hub-Spoke network and allocates VLANs and an uplink port to each user instance, such that the uplink port is able to receive and send two layers of VLAN tags including an inner layer VLAN tag IT and an outer layer VALN tag OT.

In the example shown in FIG. 1, the Hub-CE 110 creates a user instance 1 and a user instance 2. The user instances 1, 2 are connected to the Hub-PE 100 via an uplink port 1 that is shared by the user instances 1, 2. The user instance 1 uses VLANs 1 to 100 on the uplink port 1, and the user instance 2 uses VLANs 101 to 200 on the uplink port 1. The Hub-CE 110 allocates a downlink port to each user instance, e.g., a port 2 for the user instance 1 and a port 3 for the user instance 2.

Each user instance has two tables: a MAC address forwarding table and a user instance MAC address table. The MAC address forwarding table is indexed by MAC and VLAN, such that messages are transmitted within the VLAN. The user instance MAC address table is indexed by MAC, such that different VLANs can transmit messages to one another. The user instances are isolated and each of them has different user instance identifier allocated by the Hub-CE 110.

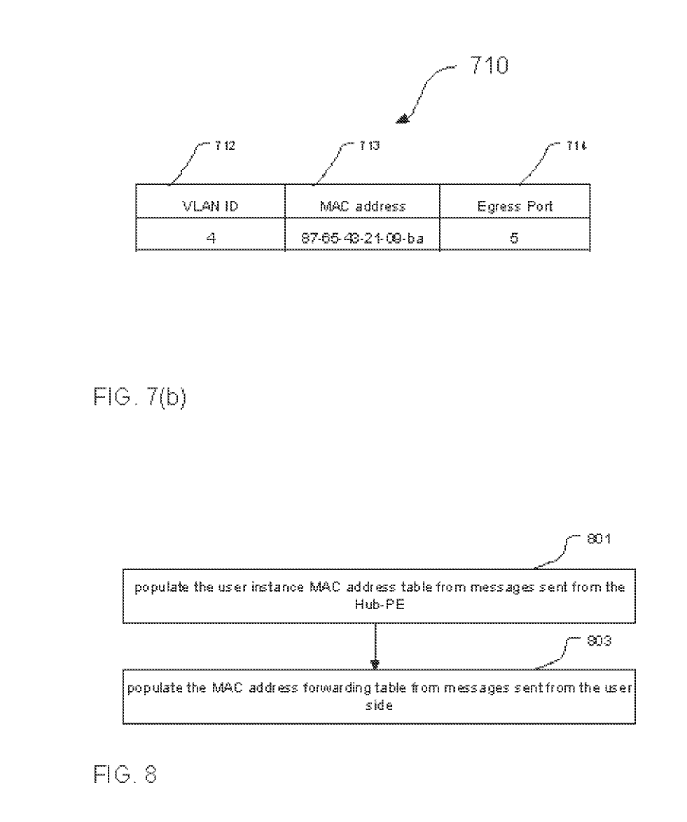

An example of the user instance MAC address table 700 is shown in FIG. 7(a). The user instance MAC address table 700 comprises a user instance identifier field 701, a VLAN ID field 702, a MAC address field 703 and an egress port field 704. The VLAN ID field 702 contains a VLAN ID contained in the outer layer VLAN tag OT of a message, identifying a Spoke-PE of the Spoke-PEs in a Hub-Spoke network. The user instance identifier field 701 contains a user instance identifier identifying the user instance or the Hub-Spoke network. Similarly, an example of the MAC address forwarding table 710 is shown in FIG. 7(b). An entry for the MAC address forwarding table 710 comprises a VLAN ID field 712, a MAC address field 713 and an egress port field 714.

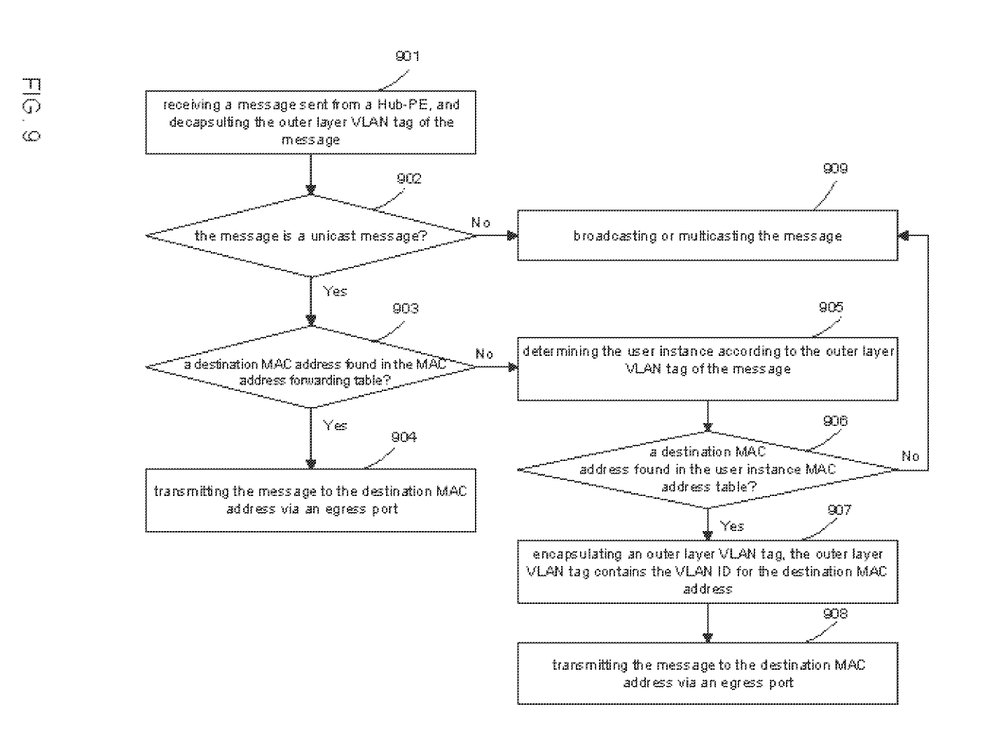

Now referring to FIGS. 1 and 8, an example method for populating a table for use in MAC addressing in the Hub-Spoke network is described.

Upon receipt of the message 1(c) from the Hub-PE 100, the Hub-CE 110 determines, based on the outer layer VLAN tag OT of the message 1(c), an entry to populate 801 the user instance MAC address table 700. On the other hand, when the Hub-CE 100 receives a message from the user side 140, a source MAC address is determined to populate 803 the MAC address forwarding table 710.

Now referring to FIG. 9, an example method for MAC addressing in a Hub-Spoke network is described, followed by a more detailed example. In the example shown in FIG. 9, the Hub-CE 110 receives from the Hub-PE 100 a message having an outer layer VLAN tag OT and an inner layer VLAN tag IT and decapsulates the outer layer VLAN tag OT of the message 901.

The Hub-CE 110 determines 902 whether the message is a unicast message. If the message is a unicast message, the Hub-CE 110 searches the MAC address forwarding table 710 entries for the inner layer VLAN tag IT of the message to further determine if a destination MAC address for the message is found 903 in an entry for the MAC address forwarding table 710. If the destination MAC address for the message is found, the Hub-CE 110 transmits 904 the message to the destination MAC address through the egress port indicated by the egress port field 714 of the entry.

If the destination MAC address is not found in the MAC address forwarding table, the Hub-CE 110 determines 905 a user instance according to the VLAN ID contained in the outer layer VLAN tag OT of the message. The Hub-CE 110 then searches the user instance MAC address table 700 entries by the user instance ID field 701 to determine whether a destination MAC address for the user instance is found 906. If the destination MAC address for the user instance is found in an entry of the user instance MAC address table 700, the Hub-CE 110 encapsulates 907 in the message an outer layer VLAN tag containing the VLAN ID in the VLAN ID field 702 of the entry. The message is then transmitted 908 to the destination MAC address through the egress port indicated by the egress port field 704 of the entry.

If the destination MAC address for the user instance is not found in the user instance MAC address table 700, the message is processed as a broadcast or a multicast message 909. That is, the Hub-CE 110 sends the message to all ports on the VLAN indicated by the inner layer VLAN tag IT of the message and to VLANs on the uplink port of the user instance except the VLAN identified by the VLAN ID contained in the outer layer VLAN tag OT of the message. Prior to sending the message to the VLANs via the uplink port, the Hub-CE 110 determines the VLAN ID of each of the VLANs and encapsulates in the message an outer layer VLAN tag OT containing the VLAN ID.

A more detailed example of the process shown in FIG. 9 is now described.

The Hub-CE 110 receives from the Hub-PE 100 a message having an inner layer VLAN tag IT and an outer layer VLAN OT. The VLAN ID contained in the outer layer VLAN tag OT of the message is 100, indicating that the message is sent from the VLAN 100 for the user instance 1. The Hub-CE 110 then decapsulates the outer layer VLAN tag OT of the message.

If the message is a unicast message, the Hub-CE 110 searches the MAC address forwarding table 710 entries for the inner layer VLAN tag IT of the message to further determine if a destination MAC address for the message is found in an entry for the MAC address forwarding table 710. If the destination MAC address for the message is found in an entry for the MAC address forwarding table 710, the message is transmitted to the destination MAC address via the egress port indicated by the egress port field 714 of the entry.

If the destination MAC address is not found in the MAC address forwarding table 710, the Hub-CE 110 determines that the user instance for the message is the user instance 1 and the user instance identifier of the user instance 1 is 1 according to the VLAN ID contained in the outer layer VLAN tag OT of the message. The Hub-CE 110 searches the user instance MAC address table 700 by the user instance identifier for an entry containing a destination MAC address for the user instance 1. The entry containing the destination MAC address (i.e., “01-23-45-67-89-ab”) for the user instance 1 is found in the user instance MAC address table 700. The Hub-CE 110 then encapsulates in the message an outer layer VLAN tag OT containing the VLAN ID (i.e., 3) contained in the VLAN ID field 702 of the entry. The message is then transmitted to the destination MAC address via the egress port 1 indicated by the egress port field 704 of the entry. If the destination MAC address for the user instance 1 is not found in the user instance MAC address table 700, the message is processed as broadcast message or a multicast message.

If the message received at the Hub-CE 110 is a broadcast or a multicast message, the Hub-CE 110 sends the message to all ports on the VLAN indicated by the inner layer VLAN tag IT of the message, and to VLANs on the uplink port 1 of the user instance 1 except VLAN 100, i.e., VLANs 1 to 99 on the uplink port 1. Prior to sending the message to the VLANs 1 to 99 via the uplink port 1, the Hub-CE 110 determines the VLAN ID of each of the VLANs 1 to 99 and encapsulates in the message an outer layer VLAN tag OT containing the VLAN ID.

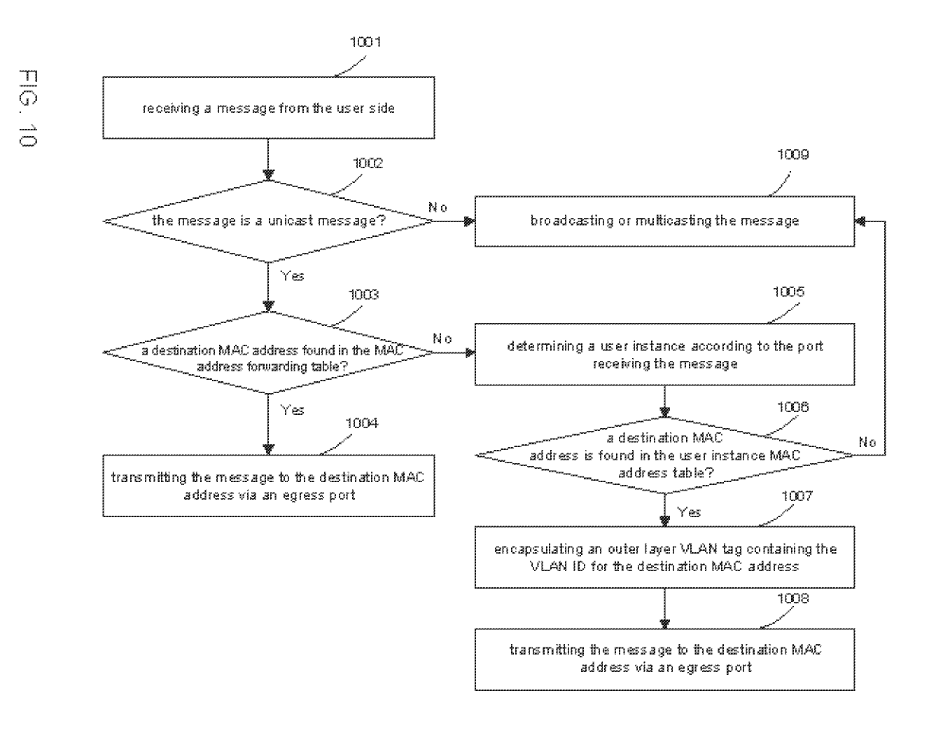

Now referring to FIG. 10, an example method for MAC addressing in a Hub-Spoke network is described followed by a more detailed example.

The Hub-CE 110 receives 1001 a message having a VLAN tag from the user side 140, the VLAN tag indicating the port from which the message is received.

The Hub-CE 110 determines 1002 whether the message is a unicast message. If the message is a unicast message, the Hub-CE 110 searches the MAC address forwarding table 710 entries in the VLAN receiving the message to determine 1003 whether a destination MAC address for the message is found. If the destination MAC address is found in an entry of the MAC address forwarding table 710, the Hub-CE 110 transmits 1004 the message to the destination MAC address via the egress port indicated by the egress port field 714 of the entry.

If the destination MAC address is not found in the MAC address forwarding table 710, the Hub-CE 110 determines 1005 a user instance according to the port receiving the message. The Hub-CE 110 then searches the user instance MAC address table 700 for the user instance to determine whether a destination MAC address of the message is found 1006. If the destination MAC address of the message is found in an entry of the user instance MAC address table 700, the Hub-CE 110 encapsulates 1007 in the message an outer layer VLAN tag OT containing the VLAN ID in the VLAN ID field 702 of the entry. The Hub-CE 110 then transmits 1008 the message via the egress port indicated by the port number field 704 of the entry.

If the destination MAC address of message is not found in the user instance MAC address table 700, the message is processed as a broadcast or a multicast message 1009. That is, the Hub-CE 110 sends the message to all ports except the port from which the message is received, which is indicated by the VLAN tag of the message, and to all VLANs for the user instance on the uplink port. Prior to sending the message to the VLANs via the uplink port, the Hub-CE 110 determines the VLAN ID of each of the VLANs and encapsulates in the message an outer layer VLAN tag OT containing the VLAN ID.

A more detailed example of the process shown in FIG. 10 is now described.

The Hub-CE 110 receives a message from the user side. The message comprises a VLAN tag indicating the message is received from the port 2.

If the message is a unicast message, the Hub-CE 110 searches the MAC address forwarding table 710 entries in the VLAN receiving the message. If a destination MAC address for the message is found in an entry of the MAC address forwarding table 710, the message is transmitted to the destination MAC address via an egress port indicated by the egress port field 714 of the entry. If the destination MAC address is not found in the MAC address forwarding table 710, the Hub-CE 110 determines that the user instance identifier for the message is 1 as the port 2 from which the messages is received is allocated to the user instance 1 by the Hub-CE 110. The Hub-CE 110 then searches the user instance MAC address table 700 for a destination MAC address for the user instance 1. If the destination MAC address for the user instance 1 is found in an entry of the user instance MAC address table 700, the Hub-CE 110 encapsulates in the message an outer layer VLAN tag OT containing the VLAN ID (i.e., 3) contained in the VLAN ID field 702 of the entry. The message is then transmitted to the destination MAC address via the egress port 1 as indicated by the egress port field 704 of the entry. If the destination MAC address for the user instance 1 is not found in the user instance MAC address table 700, the message is processed a broadcast message or multicast message.

If the message received at the Hub-CE 110 is a broadcast or a multicast message, the Hub-CE 110 sends the message to all ports of the user instance 1 except the port 2 from which the message is received, and to all VLANs (i.e., VLANs 1 to 100) for the user instance 1 on the uplink port 1. It should be noted that, as only the port 2 is allocated to the user instance 1 by the Hub-CE 110 in this example, the message is not sent to any other ports. As a variation of this example, ports other than the port 2 are allocated to the user instance 1. In this case, the message is transmitted to these ports. Further, prior to sending the message to the VLANs 1 to 100 via the uplink port 1, the Hub-CE 110 determines the VLAN ID of each of the VLANs 1 to 100 and encapsulates in the message an outer layer VLAN tag OT containing the VLAN ID.

In a general Hub-Spoke network, communications between Spoke-PEs are implemented through the Hub-PE and the Hub-CE. However, when a direct communication between Spoke-PEs is needed, the Hub-PE and the Spoke-PEs in the Hub-Spoke network are established as Hub-PEs. Further each Hub-PE considers other Hub-PEs to be Spoke-PEs. Accordingly, when the Hub-CE receives a message from a Hub-PE via the uplink port, the Hub-CE no longer transmits the message via the uplink port, as described with reference to FIG. 9, to prevent broadcasting or multicasting a message.

Referring to FIG. 11, an example Hub-PE device 1100 in a Hub-Spoke network is described.

The Hub-PE device 1100 shown in FIG. 11 comprises a processor 1101, a memory unit 1103, a bus 1105 and a port 1107. The memory unit 1103 stores data and instructions for the processor 1101 to perform functions thereof. The processor 1101 obtains the data and instructions from the memory unit 1103 via the bus 1105. The Hub-PE device 1100 communicates with other entities in the Hub-Spoke network through the port 1107.

The processor 1101 allocates a same private network identifier to the Spoke-PEs 101, 102 in the Hub-Spoke network 130 to identify the Hub-Spoke network 130, and allocates to the Spoke-PEs 101, 102 unique service identifiers to uniquely identify the Spoke-PEs 101, 102, as shown in and described with reference to FIG. 2. In this way, the service identifier can be the VLAN ID of the ACs allocated to the Spoke-PEs 101, 102. In other examples, the service identifier can be other unique service identifier that uniquely identifies the Spoke-PEs 101, 102.

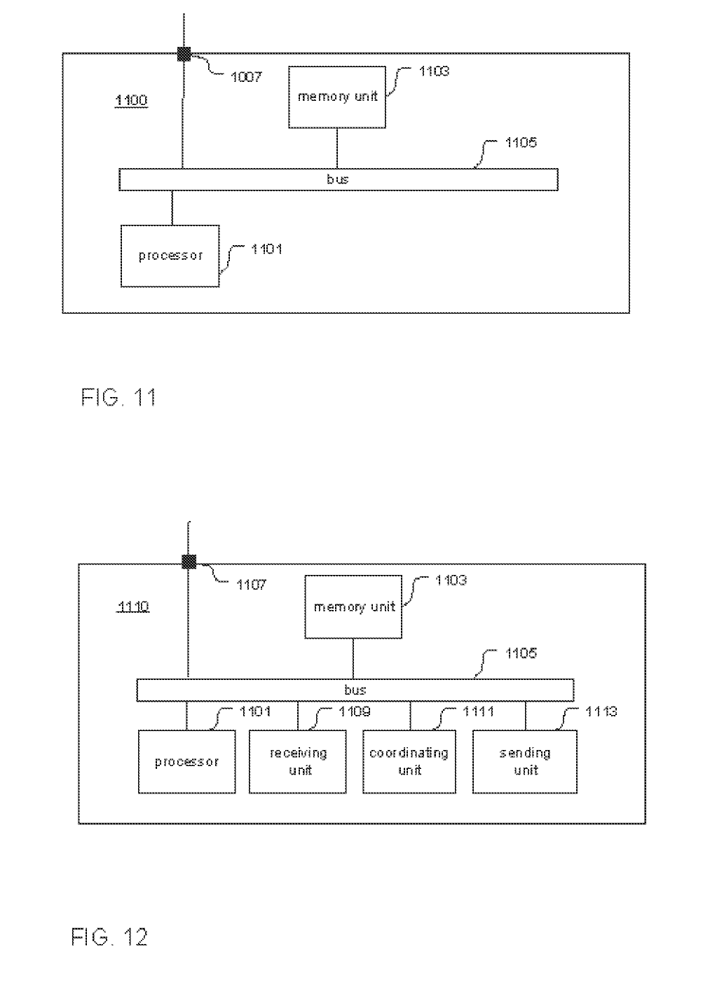

Referring to FIG. 12, an example Hub-PE device 1110 in a Hub-Spoke network is described. In addition to the elements shown in FIG. 11, the Hub-Spoke device 1110 shown in FIG. 12 further comprises a receiving unit 1109, a coordinating unit 1111 and a sending unit 1113, which obtain data and instructions from the memory unit 1103 via the bus 1105 to perform their functions.

In this example, the Hub-PE device 1110 operates as described with reference to FIGS. 5 and 6. The sending unit 1113 sends the service identifiers allocated to the Spoke-PEs 101, 102 with PW element information sent to the Spoke-PE 101, 102. Upon receipt of the PW element information, the Spoke-PEs 101, 102 obtain the service identifiers from the PW element information.

The receiving unit 1109 receives from the Spoke-PE 101 a message 1(a) shown in FIG. 1, which comprises a public network tag PubT, a private network tag PriT, an outer layer VLAND tag OT, an inner layer VLAN tag IT, and data to be communicated DA. An outer layer VLAN tag OT is encapsulated in the message 1(a) containing the service identifier (i.e., 3) allocated by the processor 1101 to the Spoke-PE 101; and the private network tag PriT is encapsulated in the message 1(a) containing the private network identifier (i.e., 26) allocated by the Hub-PE 100.

The coordinating unit 1111 decapsulates the public network tag PubT and the private network tag PriT from the message 1(a) to form message 1(b). The coordinating unit 1111 further determines whether the service identifier contained in the outer layer VLAN tag OT of the message 1(a) is the VLAN ID of the AC allocated to the Spoke-PE 101. If the service identifier contained in the outer layer VLAN tag OT of the message 1(a) is the VLAN ID of the AC allocated to the Spoke-PE 101, the sending unit 1113 then sends the message 1(b) to the Hub-CE 110 via the port 1 to be received as a message 1(c); otherwise, the coordinating unit 1111 modifies content in the outer layer VLAN tag OT of the message 1(b) from the service identifier to the VLAN ID of the AC allocated to the Spoke-PE 101 before the sending unit 1113 sends the message 1(b) to the Hub-CE 110 via the port 1. As a result, the service identifier contained in the outer layer VLAN tag OT of the message 1(b) sent by the Hub-PE 100 to the Hub-CE 110 is identical with the VLAN ID of the AC allocated to the Spoke-PE 101.

The receiving unit 1109 receives from the Hub-CE 110 a message 2(c) as shown in FIG. 1, as the service identifier contained in the outer layer VLAN tag OT of the message 2(c) is the VLAN ID of the AC allocated to the Spoke-PE 101, the AC is determined by the coordinating unit 1111 according to the service identifier contained in the outer layer VLAN tag OT. Then the PW 1 associated with the AC allocated to the Spoke-PE 101 is determined accordingly, as described above.

Then the coordinating unit 1111 encapsulates in the message 2(c) a private network tag PriT and a public network tag PubT to form a message 2(b). The private network tag PriT contains the private network identifier. The message 2(b) is sent by the sending unit 1113 to the Spoke-PE 101 through the PW 1 to be received as a message 2(a). As a variation of this example, prior to sending the message to the Spoke-PE 101, the coordinating unit 1111 modifies content in the outer layer VLAN tag OT of the message 2(b) from the service identifier to 0 in order to facilitate the processing of the message 2(a) at the Spoke-PE 101.

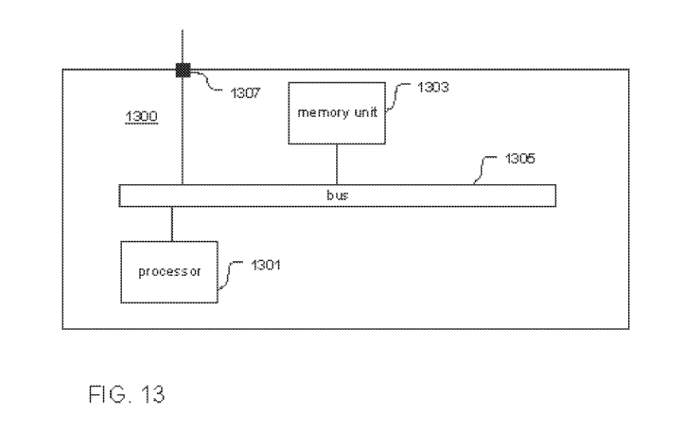

Referring to FIG. 13, an example Spoke-PE device 1300 for use in a Hub-Spoke network is described.

The Spoke-PE device 1300 shown in FIG. 13 comprises a processor 1301, a memory unit 1103, a bus 1105 and a port 1307. In this example, the Spoke-PE device 1300 operates as described with reference to FIG. 4. That is, the memory unit 1303 stores data and instructions for the processor 1301 to perform functions thereof. The processor 1301 obtains the data and instructions from the memory unit 1303 via the bus 1305. The Spoke-PE device 1300 communicates with other entities in the Hub-Spoke network through the port 1307.

The processor 1301 encapsulate tags in a message 1(a) containing data DA to be sent. Particularly, a public network tag PubT is encapsulated in the message 1(a). The Spoke-PE further encapsulates a private network tag PriT in the message 1(a). The private network tag PriT contains the private network identifier allocated to the Spoke-PE 101. An outer layer VLAN tag OT is also encapsulated in the message 1(a) and contains the unique service identifier. An inner layer VLAN tag IT is further encapsulated in the message 1(a).

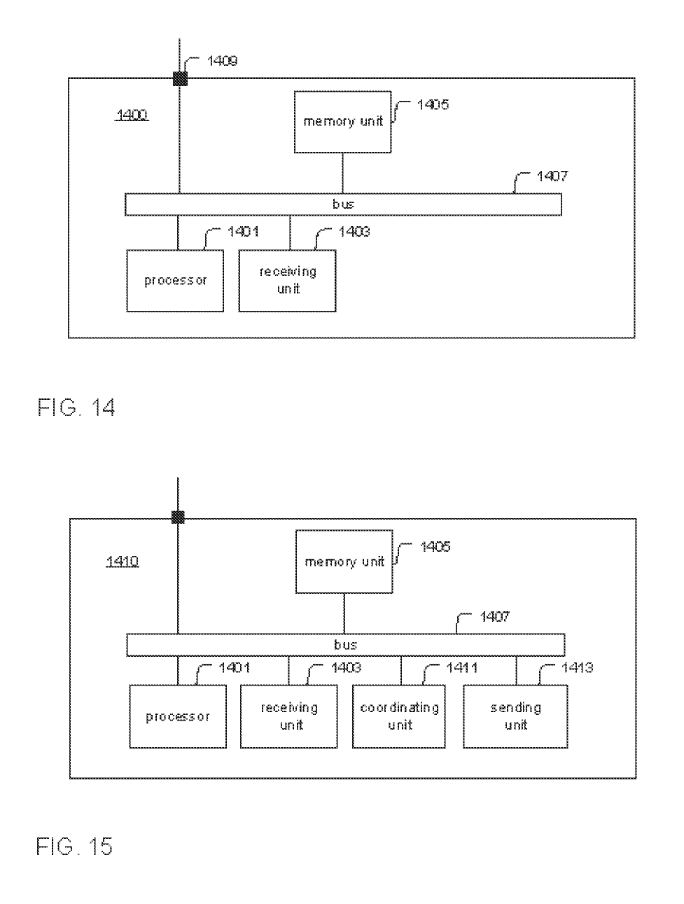

Referring to FIG. 14, an example Hub-CE device 1400 in a Hub-Spoke network is described. It should be noted that more than one user instances are used to describe the Hub-CE 1400.

The Hub-CE device 1400 shown in FIG. 14 comprises a processor 1401, a receiving unit 1403, a memory unit 1405, a bus 1407 and a port 1409. In this example, the Hub-CE device 1400 operates as described with reference to FIGS. 9 and 10. That is, the memory unit 1405 stores data and instructions for the processor 1401 and the receiving unit 1405 to perform their functions. The processor 1401 and the receiving unit 1405 in the Hub-CE device 1400 obtain the data and instructions from the memory unit 1405 via the bus 1407. The Hub-CE device 1400 communicates with other entities in the Hub-Spoke network through the port 1409.

In the example shown in FIG. 14, the processor 1401 creates a user instance 1 and a user instance 2. The user instances 1, 2 are connected to the Hub-PE 100 via an uplink port 1 that is shared by the user instances 1, 2. The user instance 1 uses VLANs 1 to 100 on the uplink port 1, and the user instance 2 uses VLANs 101 to 200 on the uplink port 1. The processor 1401 allocates a downlink port to each user instance, e.g., a port 2 for the user instance 1 and a port 3 for the user instance 2.

The receiving unit 1403 receive a message sent by the Hub-PE 100. Upon receipt the message sent from the Hub-PE 100, the processor 1401 of the Hub-CE 1400 determines, based on the outer layer VLAN tag OT of the message received, an entry to populate the user instance MAC address table 700. On the other hand, when the receiving unit 1403 receives a message from the user side, a source MAC address is determined by the processor 1401 to populate the MAC address forwarding table 700.

The memory unit 1405 stores the MAC address forwarding table 710 and the user instance MAC address table 700 as described above.

Referring to FIG. 15, an example Hub-CE device 1410 is described. In addition to the elements shown in FIG. 15, the Hub-CE device 1410 shown in FIG. 15 further comprises a coordinating unit 1411 and a sending unit 1413, which also obtain data and instructions from the memory unit 1405 via the bus 1407 to perform their functions.

The receiving unit 1403 receives from the Hub-PE 100 a message having an outer layer VLAN tag OT and an inner layer VLAN tag IT and decapsulates the outer layer VLAN tag OT of the message.

The coordinating unit 1411 determines whether the message is a unicast message. If the message is a unicast message, the coordinating unit 1411 searches the MAC address forwarding table 710 entries for the inner layer VLAN tag IT of the message to further determine if a destination MAC address for the message is found in an entry for the MAC address forwarding table 710. If the destination MAC address for the message is found, the sending unit 1413 transmits the message to the destination MAC address through the egress port indicated by the egress port field 714 of the entry.

If the destination MAC address is not found in the MAC address forwarding table 710, the coordinating unit 1411 determines a user instance according to the VLAN ID contained in the outer layer VLAN tag OT of the message. The coordinating unit 1411 then searches the user instance MAC address table 700 entries by the user instance to determine whether a destination MAC address for the user instance is found. If the destination MAC address for the user instance is found in an entry of the user instance MAC address table 700, the coordinating unit 1411 encapsulates in the message an outer layer VLAN tag OT containing the VLAN ID in the VLAN ID field 702 of the entry. The message is then transmitted to the destination MAC address through the egress port indicated by the egress port field 704 of the entry. If the destination MAC address for the user instance is not found in the user instance MAC address table 700, the message is processed as a broadcast or a multicast message.

If the message is a broadcast or multicast message, the sending unit 1413 sends the message to all ports on the VLAN identified by the inner layer VLAN tag IT of the message and to VLANs on the uplink port of the user instance except the VLAN identified by the VLAN ID contained in the outer layer VLAN tag OT of the message. Prior to sending the message to the VLANs via the uplink port, the coordinating unit 1411 determines the VLAN ID of each of the VLANs and encapsulates in the message an outer layer VLAN tag OT containing the VLAN ID.

The receiving unit 1403 receives a message having a VLAN tag from the user side, the VLAN tag indicating the port from which the message is received.

The coordinating unit 1411 determines whether the message is a unicast message. If the message is a unicast message, the coordinating unit 1411 searches the MAC address forwarding table 710 entries in the VLAN receiving the message to determine whether a destination MAC address for the message is found in an entry of the MAC address forwarding table 710. If the destination MAC address is found, the sending unit 1413 transmits the message to the destination MAC address via the egress port indicated by the egress port field 714 of the entry.

If the destination MAC address is not found in the MAC address forwarding table 710, the coordinating unit 1411 determines a user instance according to the port receiving the message. The coordinating unit 1411 then searches the user instance MAC address table 700 for the user instance to determine whether a destination MAC address of the message is found. If the destination MAC address of the message is found in an entry of the user instance MAC address table 700, the coordinating unit 1411 encapsulates in the message an outer layer VLAN tag OT containing the VLAN ID contained in the VLAN field 702 of the entry. The sending unit 1413 then transmits the message via the egress port indicated by the port number field 714 of the entry. If the destination MAC address of message is not found in the user instance MAC address table 700, the message is processed as a broadcast or a multicast message.

If the message is a broadcast or a multicast message, the sending unit 1413 sends the message to all ports except the port from which the message is received, which is indicated by the VLAN tag of the message, and to all VLANs for the user instance on the uplink port. Prior to sending the message to the VLANs via the uplink port, the coordinating unit 1411 determines the VLAN ID of each of the VLANs and encapsulates in the message an outer layer VLAN tag OT containing the VLAN ID.

Further, the processes, methods and functional units described in this disclosure may be implemented by hardware or by software. For example a plurality of machine readable instructions stored on a non-transitory storage medium and executable by a processor to implement the methods and functional units recited in the examples of the present disclosure. There may be a single processor and non-transitory storage medium or plural processors and/or storage mediums in which case the methods and functional units may be distributed between them.

The figures are only illustrations of an example, wherein the units or procedure shown in the figures are not necessarily essential for implementing the present disclosure. The units in the devices in the examples can be arranged as described, or can be located in one or more devices differently than shown in the examples. For example, the units in the examples described can be combined into one module or further divided into a plurality of sub-units.

Although the flow charts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

1. A method for allocating identifiers to Spoke-PEs in a Hub-Spoke network, the Hub-Spoke network comprising a plurality of Spoke-PEs, the method comprising:
allocating a private network identifier to the plurality of Spoke-PEs in the Hub-Spoke network, the private network identifier identifying the Hub-Spoke network;
determining a unique service identifier to uniquely identify a first Spoke-PE from the plurality of Spoke-PEs in the Hub-Spoke network;
allocating the unique service identifier to the first Spoke-PE of the plurality of Spoke-PEs; and
causing the unique service identifier to be obtained at the first Spoke-PE.

2. The method according to claim 1, the method further comprising:
encapsulating, by the first Spoke-PE of the plurality of the Spoke-PEs, a first tag in a first message, the first tag containing the private network identifier to identify the Hub-Spoke network; and
encapsulating, by the first Spoke-PE of the plurality of the Spoke-PEs, a second tag in the first message, the second tag containing the unique service identifier to uniquely identify the first Spoke-PE from the plurality of Spoke-PEs in the Hub-Spoke network.

3. The method according to claim 2, further comprising:
receiving, from the first Spoke-PE of the plurality of the Spoke-PEs, the first message having the second tag, the second tag containing the unique service identifier sent to the first Spoke-PE;
modifying content in the second tag from the unique service identifier to a virtual local area network identifier (VLAN ID) of a VLAN of an attachment circuit (AC) allocated to the first Spoke-PE.

4. The method according to claim 1, wherein the Hub-Spoke network further comprises a Hub-CE, the method further comprising:
receiving, from the Hub-CE, a second message; and
encapsulating a private network tag in the second message, the private network tag containing the private network identifier.

5. The method according to claim 1, wherein allocating identifiers is performed by a Hub-PE and the Hub-Spoke network further comprises a Hub-CE, wherein the Hub-CE performs the method comprising:
receiving a first message from the Hub-PE; and
determining from the first message, a user instance identifier identifying the Hub-Spoke network and a virtual local area network identifier (VLAN ID) uniquely identifying the first Spoke-PE from the plurality of Spoke-PEs in the Hub-Spoke network.

6. The method according to claim 5, wherein the Hub-CE further performs the method comprising:
receiving a second message having a first outer layer VLAN tag and an inner layer VLAN tag, the first outer layer VLAN tag containing a first outer layer VLAN ID;
determining a second VLAN ID based on the first outer layer VLAN ID and the inner layer VLAN tag; and
encapsulating a second outer layer VLAN tag in the second message, the second outer layer VLAN tag containing the second VLAN ID.

7. The method according to claim 6, wherein the Hub-CE further performs the method comprising:
receiving a third message having a VLAN tag;
determining a VLAN ID based on the VLAN tag; and
encapsulating an outer layer VLAN tag in the third message, the outer layer VLAN tag containing the VLAN ID.

8. A device for use in a Hub-Spoke network, the Hub-Spoke network comprising a plurality of Spoke-PEs, the device comprising:
a first memory unit to store first instructions;
and a first processor
to execute the first instructions stored in the first memory unit to allocate a private network identifier to the plurality of Spoke-PEs in the Hub-Spoke network, and to allocate a unique service identifier to a first Spoke-PE of the plurality of the Spoke-PEs in the Hub-Spoke network, the private network identifier identifying the Hub-Spoke network and the unique service identifier uniquely identifying the first Spoke-PE, and
to cause the unique service identifier to be obtained at the first Spoke-PE.

9. The device according to claim 8, wherein the first Spoke-PE of the plurality of Spoke-PEs comprises:
a second memory unit to store second instructions;
and
a second processor to execute the second instructions stored in the second memory unit to encapsulate a first tag and a second tag in a first message, the first tag containing the private network identifier to identify the Hub-Spoke network and the second tag containing the unique service identifier to uniquely identify a Spoke-PE from the plurality of Spoke-PEs in the Hub-Spoke network.

10. The device according to claim 9, further comprising:
a first receiving unit to receive, from the first Spoke-PE of the plurality of the Spoke-PEs, the first message having the second tag, the second tag containing the unique service identifier allocated to the first Spoke-PE; and
a first coordinating unit to modify content in the second tag from the unique service identifier to a virtual local area network identifier (VLAN ID) of a VLAN of an attachment circuit (AC) allocated to the first Spoke-PE.

11. The device according to claim 8, wherein the Hub-Spoke network further comprises a Hub-PE, the Hub-CE comprises:
the first receiving unit further to receive, from the Hub-CE, a second message; and
the first coordinating unit further to encapsulate a private network tag in the second message, the private network tag containing the private network identifier.

12. A device of a Hub-Spoke network comprising a Hub-PE and a plurality of Spoke-PEs, the device comprising:
a receiving unit to receive, from the Hub-PE, a first message; and
a processing unit to determine from the first message, a user instance identifier identifying the Hub-Spoke network and a virtual local area network identifier (VLAN ID) uniquely identifying a first Spoke-PE from the plurality of Spoke-PEs in the Hub-Spoke network.

13. The device according to claim 12, wherein:
the receiving unit further to receive a second message having a first outer layer VLAN tag and an inner layer VLAN tag, the first outer layer VLAN tag containing a first VLAN ID;
the device further comprising:
a coordinating unit to determine a second VLAN ID based on the first VLAN ID and the inner layer VLAN tag, and to encapsulate a second outer layer VLAN tag in the second message, the second outer layer VLAN tag containing the second VLAN ID.

14. The device according to claim 13, wherein:
the receiving unit further to receive a third message having a VLAN tag;
the coordinating unit to determine a VLAN ID based the VLAN tag and to encapsulate an outer layer VLAN tag in the third message, the outer layer VLAN tag containing the VLAN ID.
